(19) United States
(12) Patent Application Publication
(10) Pub. No.: US 2009/0218173 A1
(43) Pub. Date: Sep. 3, 2009

(54) Aerial Work Platform with Compact Air Compressor

(75) Inventor: Richard Beeson, Appleton, WI (US)

Correspondence Address: FLETCHER YODER (ILLINOIS TOOL WORKS INC.), P.O. BOX 692289, HOUSTON, TX, 77269-2289, US

(73) Assignee: ILLINOIS TOOL WORKS INC., Glenview, IL (US)

(21) Appl. No.: 12/040,568

(22) Filed: Feb. 29, 2008

(51) Int. Cl. B66F 9/22

(52) U.S. Cl. 187/234; 187/267; 187/414

(57) ABSTRACT

An aerial work platform, in one embodiment, includes a platform, including a hydraulic lift, and a base unit. The base unit includes a combustion engine and a hydraulic pump driven by the combustion engine. The hydraulic pump may be configured to drive the hydraulic lift. The base unit may also include a rotary screw type compressor, belt-driven by the combustion engine.

### BACKGROUND

The invention relates generally to temporary lift platforms and, more particularly, aerial work platforms (AWPs).

Aerial work platforms (AWPs) generally lift an operator to a desired location at a worksite. Often, the operator requires services, such as pressurized air and electricity. These services enable the use of air-driven tools and electrical tools. In many cases, the operator receives these services from stand-alone units on the ground, i.e., separate from the AWP. For example, the stand-alone units may include a stand-alone electrical generator and a stand-alone air compressor. Unfortunately, the operator must independently setup, move, and generally control both the AWP and the stand-alone units, thereby reducing efficiency at the worksite. The stand-alone units also increase costs due to the need for their own power sources (e.g., engine), control systems, enclosures, wheels, and so forth. Furthermore, the stand-alone air compressor generally includes a reciprocating type (e.g., piston and cylinder) air compressor, which requires a tank to hold the compressed air. Unfortunately, the reciprocating type air compressor requires considerable space to accommodate the tank. Without the tank, the reciprocating type air compressor does not provide a generally constant air pressure to the operator due to the reciprocating mechanism, e.g., piston in cylinder. Unfortunately, many air-driven tools require a generally constant air pressure.

### BRIEF DESCRIPTION

An aerial work platform, in one embodiment, includes a platform, including a hydraulic lift, and a base unit. The base unit includes a combustion engine and a hydraulic pump driven by the combustion engine. The hydraulic pump may be configured to drive the hydraulic lift. The base unit may also include a rotary screw type compressor, belt-driven by the combustion engine.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical side view illustrating an aerial work platform in accordance with certain embodiments of the present invention;

FIGS. 2-7 are diagrammatical side views illustrating a base unit and several components of the aerial work platform as illustrated in FIG. 1 in accordance with certain embodiments of the present invention; and

FIG. 8 is a flowchart illustrating a process for controlling and operating the aerial work platform as illustrated in FIGS. 1-6 in accordance with certain embodiments of the present invention.

### DETAILED DESCRIPTION

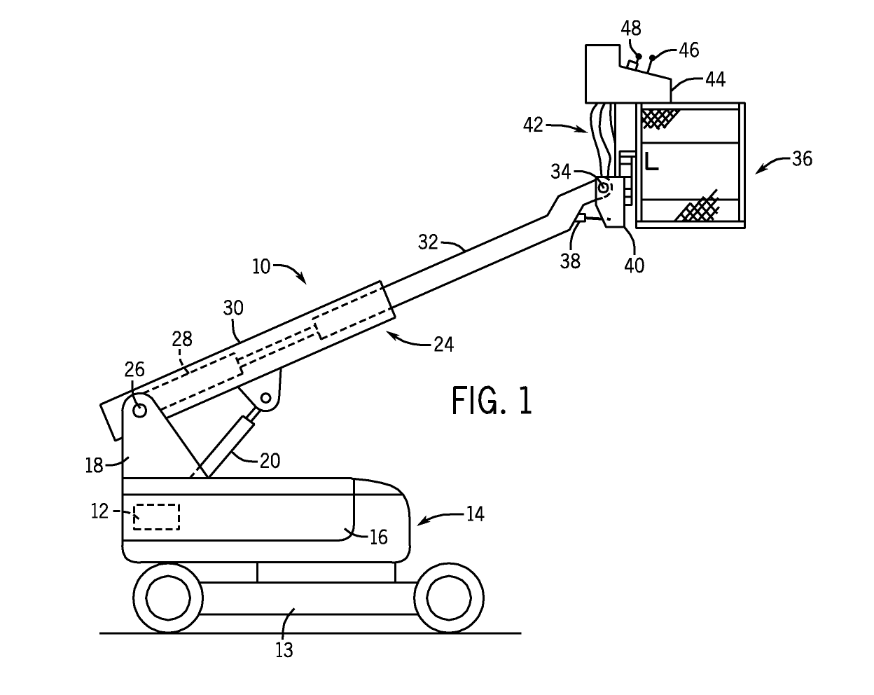

Turning now the drawings, FIG. 1 illustrates an aerial work platform (AWP) 10 including a rotary air compressor 12. Aerial work platform 10 also includes wheeled chassis 13 (e.g., chassis having four wheels) and aerial work platform base unit 14. As will be discussed in further detail below, aerial work platform 10 may provide various services or resources, such as compressed air and electric power, to an elevated worker. Various devices within AWP base unit 14, such as rotary air compressor 12, may provide these resources.

In the illustrated embodiment of FIG. 1, the rotary air compressor 12 may include a rotary screw compressor or other suitable compressor configured to supply a continuous flow of compressed air without the need for an intermediate storage tank. The rotary screw compressor 12 may include a type of gas compressor that has a rotary-type positive displacement mechanism. The rotary screw compressor 12 may include one or more screws, which rotate within an enclosure to gradually shrink a series of passages defined by threads of the screws and the surrounding enclosure. For example, the rotary screw compressor 12 may include a plurality of counter-rotating screws, which intermesh with one another to progressively reduce air volumes between the intermeshed threads. Air is drawn in through an inlet port in the enclosure, the gas is captured in a cavity, the gas is compressed as the cavity reduces in volume, and the gas is finally discharged through another port in the enclosure.

The rotary screw compressor 12 provides many benefits in cost, performance, and efficiency as compared with a reciprocating compressor (e.g., piston-in-cylinder compressor). For example, the rotary screw compressor 12 outputs a generally constant pressure of compressed gas (e.g., air) directly to the desired application without an intermediate storage tank. In contrast, a reciprocating compressor generally requires an intermediate storage tank due to the reciprocating nature of compressing the air, e.g., fluctuations in the pressure. Without a storage tank, the typical reciprocating compressor would provide compressed gas with a generally fluctuating pressure, which is not suitable for many applications. Accordingly, the rotary screw compressor 12 may provide a direct supply of compressed air on demand to a desired application, e.g., the elevated platform. In other words, in contrast to a reciprocating compressor, the rotary screw compressor 12 provides compressed air at the desired pressure immediately (e.g., in real time) to an operator located on the elevated platform, rather than compressing an intermediate storage tank until a desired pressure is reached and then subsequently supplying the air to the operator. Thus, the rotary screw compressor 12 may run only when an operator demands compressed gas (e.g., air), such that the compressor 12 is normally off when compressed gas is not needed by the operator. In contrast, the reciprocating compressor typically operates intermittently (e.g., often when an operator is not demanding air pressure) to maintain a minimum level of air pressure in the storage tank. Furthermore, the time delay associated with reciprocating compressors and their associated tanks can reduce the efficiency at the worksite. In addition, the rotary screw compressor 12 can save space due to the exclusion of an intermediate storage tank.

The rotary screw compressor 12 also has fewer moving parts than a typical reciprocating compressor, thereby reducing complexity and maintenance costs. Further, the rotary screw compressor 12 may operate to compress any type of gas, in addition to air, as is presently contemplated. The rotary screw air compressor 12 may be configured to operate at high speeds and, therefore, may use less gearing and space to couple the rotary screw compressor 12 to an engine. For example, in one embodiment, the rotary screw compressor 12 may operate at a speed near an engine speed, such as 4000 RPM. Thus, the screw compressor driving mechanism, e.g., a combustion engine, may include similar drive ratios and may not use a significantly larger driving mechanism to step down the engine speed in order to accommodate the air compressor 12.

As illustrated in FIG. 1, the integration of the rotary screw compressor 12 within the AWP 10 also provides many benefits in cost, performance, and efficiency. For example, the rotary screw compressor 12 and the AWP 10 may share a variety of components to reduce costs and complexity of the overall system, while also improving the ease of use, controllability, serviceability, and mobility of the components. For example, the compressor 12 and the AWP 10 may share a common enclosure (e.g., base unit 14), power source (e.g., engine), control system (e.g., control board, software, user interface, etc.), cooling system (e.g., water or air cooling), transportation system (e.g., wheels, transmission, etc.), and so forth. By further example, a single engine may power a hydraulic pump, an electrical generator, the compressor 12, and a drive system (e.g., transmission, wheels, etc.) of the AWP 10. The integration of the compressor 12 and the AWP 10 also enables joint movement around a worksite.

Turning now to details of the AWP 10, various embodiments of the AWP 10 may include an articulated lift, telescopic lift, a scissor lift, or another suitable lift mechanism. In the illustrated embodiment, the AWP 10 may be described as a telescopic lift. Telescopic lifts may be hydraulically powered, and are the closest in appearance to a crane. They may consist of a number of jointed sections, which can be controlled to extend the lift in a number of different directions, which can often include ‘up and over’ applications. This type of AWP is widely used for maintenance and construction of all types, including extensive use in the power and telecommunications industries to service overhead lines, and in arboriculture to provide an independent work platform on difficult or dangerous trees.

Some telescopic lifts are limited to only the distance accessible by the length of each boom arm. However, by the use of telescoping sections, the range can be vastly increased. Telescopic lifts may include a wide supportive base unit 14 and/or extending legs/struts to provide support and stability for a load on the telescoping sections. These legs may be manual or hydraulic depending on the size and complexity of the AWP 10.

Another embodiment of the AWP 10 may be described as a scissor lift. A scissor lift is a type of platform which can usually only move in the vertical plane. The mechanism used to achieve this may include linked, folding supports in a crisscross (e.g., X-shaped) pattern. The upward motion is achieved by the application of pressure to the outside of the lowest set of supports, elongating the crossing pattern, and propelling the work platform vertically. The platform may also have an extending bridge to enable closer access to the work area, because of the inherent limits of vertical only movement. The contraction of the scissor action may be hydraulic, pneumatic, and/or mechanical (e.g., via a leadscrew or rack and pinion system). Depending on the power system employed on the lift, it may not use any power to enter descent mode, but rather a simple release of hydraulic or pneumatic pressure. This is a main reason that these methods of powering the lifts may be preferred, as it allows a fail safe option of returning the platform to the ground by release of a manual valve.

The AWP 10 may be designed for mobile use at a worksite, between sites, or both. Thus, the AWP 10 may include wheels, a motor, a transmission, a hitch, or a combination thereof. In some instances, the AWP 10 may exclude a motive drive, such that it relies on external force for movement. In such an embodiment, the external force may be applied by an operator (e.g., manual force), a vehicle, or another piece of equipment capable of pushing or pulling the AWP 10. Thus, one embodiment of the AWP 10 includes wheels without any drive coupled to the wheels, wherein the AWP 10 includes a vehicle hitch, a tow connector (e.g., loop), manual push and/or pull handles, or a combination thereof. In some embodiments, the AWP 10 may be designed as a small lightweight unit, which can be transported in a truck bed and/or can be moved through a standard doorway.

In other embodiments, the AWP 10 may be self propelled via a suitable drive coupled to wheels, tracks, or the like. These AWP 10 units are able to drive (on wheels or tracks) around a site without need for any external force. In some instances, these AWP 10 units are able to move while a job is in progress, e.g., while an operator is positioned on a platform raised to a desired altitude by the AWP 10. However, such movement may not be possible with AWP 10 units having secure outriggers (e.g., extending legs or struts). In self-propelled AWP 10 units, the drive may include an electric motor, a spark ignition internal combustion engine, a compression ignition (e.g., diesel) engine, a hybrid power unit, and so forth. Furthermore, the AWP 10 may include a suitable transmission coupling the motor to the wheels. The transmission may include an automatic transmission or a manual transmission having a clutch.

Referring now to the AWP 10 shown in FIG. 1, the AWP 10 includes a hood 16 that opens and closes (e.g., via a hinge) to provide access to internal components (e.g., rotary compressor 12) within the base unit 14. Located on top of the base unit 14 is a bracket 18, which is coupled to one or more lift cylinders 20. Lift cylinder 20 is configured to move a boom 24 up and down via rotation about a pivot joint 26, e.g., a pin or axial joint. The lift cylinder 20 may include one or more hydraulic cylinders, one or more pneumatic cylinders, a screw-driven mechanism, or any combination thereof. As illustrated, the lift cylinder 20 provides leverage offset from the joint 26, thereby enabling rotational movement of the boom 24 between a generally horizontal and a generally upright or raised orientation relative to the ground.

Further, an actuator 28 may be located inside the boom 24 in order to extend or retract the boom unit. Again, like the lift cylinder 20, the actuator 28 may include a hydraulic cylinder, a pneumatic cylinder, a screw-driven mechanism, or a combination thereof. The illustrated boom 24 includes a base 30 coupled to a fly section 32, wherein the fly section 32 is extendable and retractable (e.g., telescopic) relative to the base 30. Thus, the actuator 28 can provide a force to extend the fly section 32, thereby increasing the length of the boom 24. The actuator 28 also may provide a controlled retraction of the fly section 32 relative to the base 30, e.g., by releasing pressure of hydraulic fluid, air, or the like.

The boom 24 is coupled via a pivot joint 34 (e.g., a pin or axial joint) to a platform 36. The platform 36 is configured to support one or more operators and some amount of equipment, which depends on the load capability of the AWP 10. A cylinder 38 (e.g., hydraulic or pneumatic) may be coupled to the boom 24 and a pivot assembly 40 in order to position the platform 36. Devices within the shell base unit 14 may be connected to platform 36 via electrical cables, hydraulic conduits, pneumatic conduits, control cables, and other linkages, as indicated by cables 42. The cables 42 may provide control and access to the resources of the AWP 10 to the elevated worker. Control panel 44 provides control and access to services provided by base unit 14. In certain embodiments, control panel 44 may include various gauges, displays, switches, keypads, service connections, and general controls, as indicated by reference numerals 46 and 48. For example, the control panel 44 may include one or more compressed air outputs, hydraulic outputs, electrical outputs, and so forth. The control panel 44 also may include one or more gauges and/or displays indicating air pressure, hydraulic pressure, electrical output voltage, electrical output current, engine speed, engine temperature, platform altitude, and other parameters. The control panel 44 also may include controls to stop, start, or vary parameters of the engine, the compressor 12, the electrical generator. The control panel 44 also may include steering and drive controls in order to move and maneuver the base unit 14 while the worker is positioned in the platform 36.

As generally illustrated in FIG. 1, certain embodiments of the base unit 14 exclude a driver cab, a driver seat, a driver steering wheel, and the like. Thus, embodiments of the AWP 10 are distinctly and contrastingly different from a vehicle having a chassis with an integral driver cab and lift mechanism. In the illustrated embodiment of FIG. 1, the control panel 44 on the platform 36 may provide controls to enable the operator to generally drive the AWP 10 around the worksite, between worksites, and so forth. However, in some embodiments, the AWP 10 may include some controls on the base unit 14 as well.

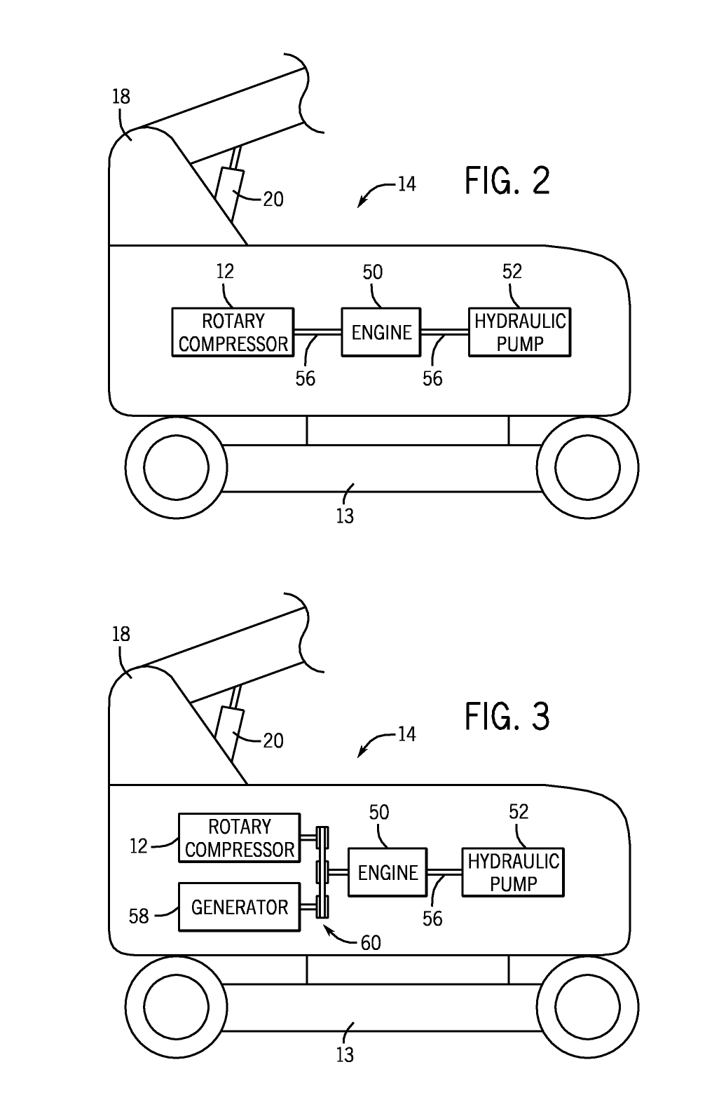

FIG. 2 illustrates a diagram of the AWP base unit 14 and internal components in accordance with certain embodiments of the present technique. As illustrated in FIG. 2, the base unit 14 includes a power pack or service package having the rotary screw compressor 12, a combustion engine 50, and a hydraulic pump 52. In the diagram, the devices are coupled by drive mechanism 56. Drive mechanism 56 may include shafts, pulleys, belts, gears, clutches, or any combination thereof. Gears or belts/pulleys may be used in some embodiments to step up the output of the engine to drive the rotary compressor at a sufficient rate (RPM). For instance, a rotary compressor may need to operate at a minimum 4000 RPM and the engine may operate at a maximum of 2800-3000 RPM. Therefore, a drive system must step up the output of the engine to operate the compressor. However, as illustrated in FIG. 2, the drive mechanism 56 consists essentially of a direct drive (e.g., direct drive shaft) between the engine 50 and both the rotary compressor 12 and the hydraulic pump 52. In this embodiment, the drive mechanism 56 generally excludes clutches, pulleys, and the like. The direct drive (e.g., drive shaft) may be desirable to minimize lost power during transfer and to reduce maintenance by having fewer moving parts. In some embodiments, the AWP base unit 14 may include a power pack or service package, which may consist essentially of the rotary screw air compressor 12, the engine 50, and the hydraulic pump 52. In other words, the power pack does not include a compressor tank, a reciprocating air compressor, and an electrical generator. The inclusion of the rotary screw air compressor 12 in the AWP 10 generally eliminates the need for a connection to a stand-alone air compressor.

FIG. 3 illustrates a diagram of the AWP base unit 14 and internal components in accordance with certain embodiments of the present technique. As illustrated in FIG. 3, the base unit 14 includes a power pack or service package having the rotary screw air compressor 12, the engine 50, the hydraulic pump 52, and an electrical generator 58. Also included in AWP base unit 14 is a belt drive system 60, which may be used to couple engine 50 to the other components. The illustrated belt drive system 60 includes three pulleys and a single belt disposed about these three pulleys. In other embodiments, the system 60 may employ multiple belts, a chain coupled to sprockets on the components, gears, or another suitable arrangement. As previously mentioned, the rotary screw air compressor 12 may not require a compressor pulley (or chain sprocket) to step up the engine speed of the engine 50 to accommodate the rotary screw air compressor 12. In other embodiments, the pulley may be used to step down the engine speed. The engine 50 may be a spark ignition (i.e., gasoline), a compressor ignition engine (i.e., diesel), or similar engine outputting up to 100 horsepower.

The generator 58 may be coupled to the engine 50 as illustrated in FIG. 3 or with an additional clutch or selective engagement mechanism. In operation, the generator 58 converts the power output (e.g., mechanical energy) of the engine 50 to electrical power. Generally, the generator 58 includes an assembly configured to convert a rotating magnetic field into an electrical current (e.g., AC generator). The generator 58 includes a rotor (rotating portion of the generator) and a stator (the stationary portion of the generator). For example, the rotor of the generator 58 may include a rotating drive shaft disposed in a single stator configured to create an electrical current (e.g., a welding current) from the rotation of the magnetic field. In certain embodiments, the generator 58 may include a four-pole rotor and three-phase weld output configured to provide beneficial welding characteristics. Further, the generator 58 may include a plurality of independent winding sections in the rotors and/or stators, such that the generator 58 is configured to output multiple electrical outputs having different characteristics. For example, the generator 58 may include a first section configured to drive a welding current to a welding gun (e.g., a MIG welding gun) and a second section configured to drive a current for other AC outputs (e.g., auxiliary devices). In certain embodiments, the generator 58 may include power conditioning circuitry, and may be configured to provide both AC and DC output.

With reference to the features shown in FIG. 3, several embodiments are presently contemplated with somewhat limited features of the power pack or service package noted above. In a first contemplated embodiment, the AWP base unit 14 may include a power pack or service package, which may consist essentially of the rotary compressor 12, the engine 50, the hydraulic pump 52, and the generator 58. In a second contemplated embodiment, the AWP base unit 14 may include a power pack or service package, which may consist essentially of the rotary compressor 12, the engine 50, the hydraulic pump 52, the generator 58, and the belt drive system 60. In a third contemplated embodiment, the AWP base unit 14 may include a power pack or service package, which may consist essentially of the rotary compressor 12, the engine 50, and the generator 58. In a fourth contemplated embodiment, the AWP base unit 14 may include a power pack or service package, which may consist essentially of the rotary compressor 12, the engine 50, the generator 58, and the belt drive system 60. In the third and fourth contemplated embodiments, the rotary compressor 12 may drive the articulated lift or boom 24 and also various pneumatic tools used by the operator in the platform 36. In these four contemplated embodiments, the AWP base unit 14 may be described as excluding a reciprocating compressor and an air storage tank. Furthermore, other embodiments are contemplated with or without any of the components shown in FIG. 3.

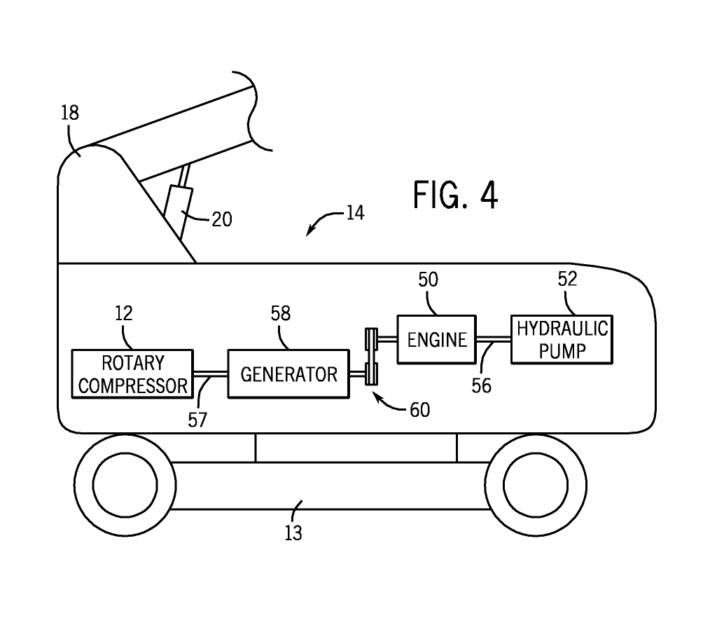

FIG. 4 illustrates a diagram of the AWP base unit 14 and internal components in accordance with certain embodiments of the present technique. In the present embodiment, the AWP base unit 14 may include a power pack or service package, which may consist essentially of the rotary compressor 12, the engine 50, the hydraulic pump 52, and the generator 58. In the illustrated arrangement, the engine 50 drives the generator 58 by belt drive system 60. The rotary compressor 12 is then coupled to drive mechanism 57, which is driven by generator 58. Drive mechanism 57 may include shafts, pulleys, belts, gears, clutches, or any combination thereof. Engine 50 also drives the hydraulic pump 52 via drive mechanism 56. The arrangement show in FIG. 4 may be referred to as a piggy back configuration. Specifically in the embodiment the devices are driven by the engine 50 in series, meaning the engine 50 drives the generator 58, which in turn drives the rotary compressor 12. In another embodiment, the series arrangement may have the engine 50 drive the rotary compressor 12, which in turn drives the generator 58. In the series arrangement, both the generator and rotary compressor are both mechanically driven by the engine, yet only one device is directly coupled to the engine. The series configuration is an alternative to the parallel arrangement, shown in FIG. 3, where the rotary compressor 12 and generator 58 are both driven by the engine 50.

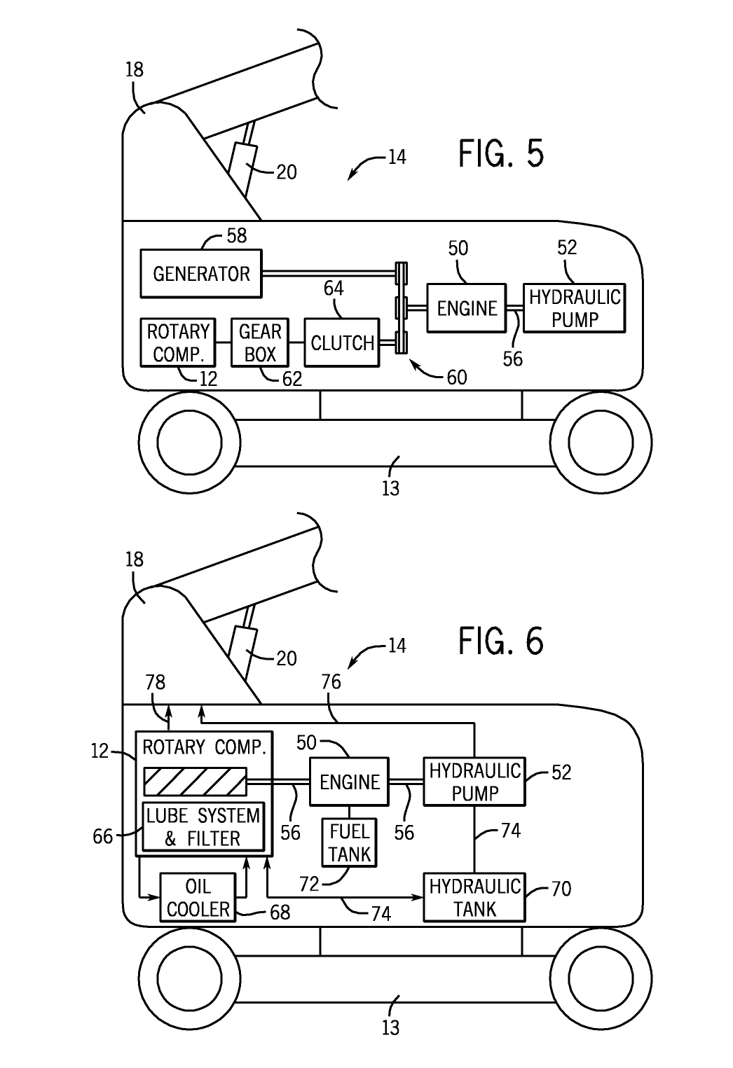

FIG. 5 illustrates a diagram of the AWP base unit 14 and internal components in accordance with certain embodiments of the present technique. As illustrated in FIG. 5, the base unit 14 includes a power pack or service package having the rotary screw air compressor 12, the engine 50, the hydraulic pump 52, the generator 58, the belt drive system 60, a gear box 62, and a clutch 64. In the present embodiment, the gear box 62 and/or clutch 64 may be used to engage, change speeds, and/or change the direction of rotary screw air compressor 12. Any one of the devices of AWP base unit 14 may be similarly clutched to allow for separate control of the components. Such control may be useful for controlling the power draw on the engine, particularly when no load is drawn from the particular component. For example, in one embodiment, a single clutch may be employed to simultaneously engage and disengage both the compressor 12 and the generator 58. In another embodiment, a first clutch (e.g., clutch 64) may be used for the compressor 12, and a separate independent clutch may be used for the generator 58.

In the present embodiment, the belt drive system 60 is used to couple the engine 50 to the rotary screw air compressor 12 and the generator 58. The generator 58 may be used to provide AC and/or DC power for various applications, such as electrical tools, a welding gun (e.g., MIG welding gun), a cutting torch (e.g., plasma cutting torch), electrical lighting, and so forth. In some embodiments of the AWP 10, the boom 24 may include an electrically powered lift system, rather than using hydraulics or pneumatics to lift the boom 24. In such an embodiment, the generator 58 may be used to power the lift system of the boom 24. Further, in the illustrated embodiment, the hydraulic pump 52 is directly coupled to the engine 50 via the drive mechanism 56. The hydraulic pump 52 may be used to drive a hydraulic lift system of the boom 24, a hydraulically driven stabilizer (e.g., struts or legs on the base unit 14), hydraulic tools, and so forth.

With reference to the features shown in FIG. 5, several embodiments are presently contemplated with somewhat limited features of the power pack or service package noted above. In a first contemplated embodiment, the AWP base unit 14 may include a power pack or service package, which may consist essentially of the rotary compressor 12, the engine 50, the hydraulic pump 52, the generator 58, the gear box 62, and the clutch 64. In a second contemplated embodiment, the AWP base unit 14 may include a power pack or service package, which may consist essentially of the rotary compressor 12, the engine 50, the hydraulic pump 52, the generator 58, the gear box 62, the clutch 64, and the belt drive system 60. In a third contemplated embodiment, the AWP base unit 14 may include a power pack or service package, which may consist essentially of the rotary compressor 12, the engine 50, the hydraulic pump 52, and the clutch 64. In a fourth contemplated embodiment, the AWP base unit 14 may include a power pack or service package, which may consist essentially of the rotary compressor 12, the engine 50, the hydraulic pump 52, the generator 58, and the clutch 64. In these four contemplated embodiments, the AWP base unit 14 may be described as excluding a reciprocating compressor and an air storage tank. Furthermore, other embodiments are contemplated with or without any of the components shown in FIG. 5.

FIG. 6 illustrates a diagram of the AWP base unit 14 and internal components in accordance with certain embodiments of the present technique. As illustrated in FIG. 6, the base unit 14 includes a power pack or service package having the rotary screw compressor 12, the engine 50, and the hydraulic pump 52. In the illustrated embodiment, the compressor 12 is a single screw rotary compressor. The illustrated rotary compressor 12 also may be described as an integrated rotary compressor, which includes many components of the lubrication system, including an oil filter and oil separator, which are represented by numeral 66. Oil cooler 68 is coupled to the screw compressor 12 and may be used to cool the lubricant after it is heated by the compressor 12. In some embodiments, the compressor 12 may circulate lubricant separate from other components in the AWP 10. However, in other embodiments, such as illustrated in FIG. 6, the compressor 12 may share resources (e.g., lubricant) with other components in the AWP 10.

In the illustrated embodiment of FIG. 6, the rotary compressor 12 uses hydraulic fluid from the hydraulic pump 52 as lubricant for internal components of the compressor 12. Thus, as illustrated, the base unit 14 may store hydraulic fluid in a tank 70 for use by both the hydraulic pump 52 and the rotary compressor 12. In an embodiment, the rotary screw compressor 12 may use hydraulic fluid, supplied by hydraulic tank 70, as a lubricant for the screws, bearings, seals, and other moving parts. In other embodiments, the hydraulic fluid stored in the tank 70 may be used with other components in the base unit 14, e.g., an electrical generator (e.g., bearing lubricant), an engine (e.g., motor lubricant), a transmission (e.g., transmission fluid), axle lubricant, joint lubricant, and so forth.

Further, a fuel tank 72 is coupled to the engine 50. The fuel tank 72 may include gasoline fuel, diesel fuel, natural gas, or another fuel source, depending on the type of engine 50. If the engine is a two-stroke engine 50, then the base unit 14 may further include a supplemental tank to store two-stroke engine oil, which mixes with the fuel stored in the tank 72. The base unit 14 also includes hydraulic lines (e.g., 76) to distribute hydraulic fluid to various components. Hydraulic line 76 and pressurized air line 78 may be used to route these services to the elevated platform 36.

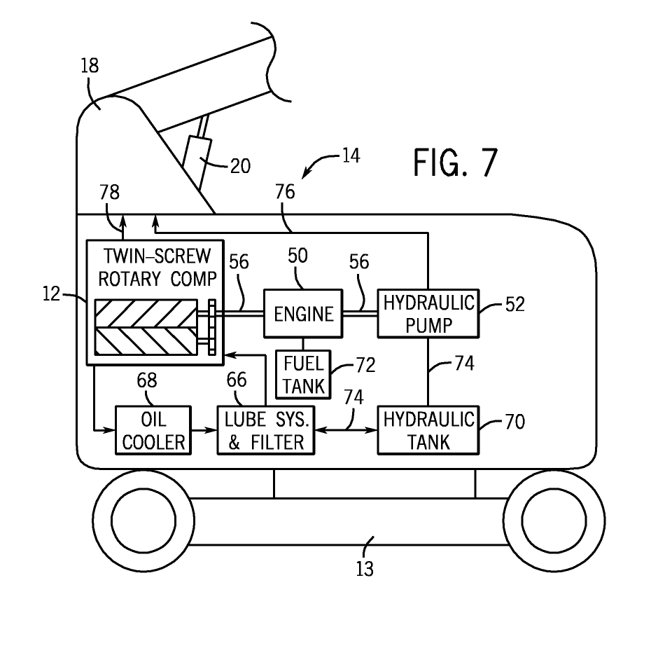

FIG. 7 illustrates a diagram of the AWP base unit 14 and internal components in accordance with certain embodiments of the present technique. As illustrated in FIG. 7, the base unit 14 includes a power pack or service package having the rotary screw compressor 12, the engine 50, and the hydraulic pump 52. In the illustrated embodiment, the rotary compressor 12 is a twin-screw compressor. The illustrated compressor 12 also may be described as a non-integrated compressor 12, because certain components are external and/or separate rather than internal as shown in FIG. 6. Specifically, in the illustrated embodiment, the compressor 12 is coupled to external lubrication components, such as the lubrication system and filter 66 and oil cooler 68. In some embodiments, the compressor 12 may circulate lubricant separate from other components in the AWP 10. However, in other embodiments, such as illustrated in FIG. 7, the compressor 12 may share resources (e.g., lubricant) with other components in the AWP 10.

In the illustrated embodiment of FIG. 7, the rotary compressor 12 uses hydraulic fluid from the hydraulic pump 52 as lubricant for internal components of the compressor 12. Thus, as discussed above with reference to the embodiment of FIG. 6, the base unit 14 of FIG. 7 may store hydraulic fluid in the tank 70 for use by both the hydraulic pump 52 and the rotary compressor 12. In the embodiment, pressurized hydraulic fluid and pressurized air may be supplied to the boom 24 and elevated platform 36 by lines 76 and 78, respectively.

Referring now to FIGS. 1-7, several devices may be included in AWP 10, depending on the services that are desired. As more devices are added to the AWP 10, the power demanded by the devices may exceed the power (e.g., electrical, mechanical, pneumatic) produced by the engine 50, the generator 58, the rotary compressor 12, or a combination thereof. For example, the engine 50 may be overloaded and unable to operate all of the devices simultaneously. Thus, the power output to each device may be reduced in proportion to the limited power, and the available power may be distributed between all of the devices consuming power from the engine 50. Unfortunately, certain devices may not function properly when operating from the reduced power level. A solution may include an AWP 10 incorporating a larger and more powerful engine 50 capable of providing increased amounts of power. However, as engine size increases, the weight and cost of the engine 50 may also increase. Thus, an embodiment of the present AWP 10 may include a smaller engine 50 with a reduced power output to increase portability and reduce cost. Accordingly, certain priority control features of the AWP 10 may monitor and control distribution of power to the various devices based on priority levels, available power, and operational conditions. Further, it may be desirable to increase the efficiency of the AWP 10 by reducing the power generated by the engine 50 when the available power exceeds the demand. The following discussion presents a control system and method configured to monitor operations of the AWP 10 and distribute power based on a priority scheme.

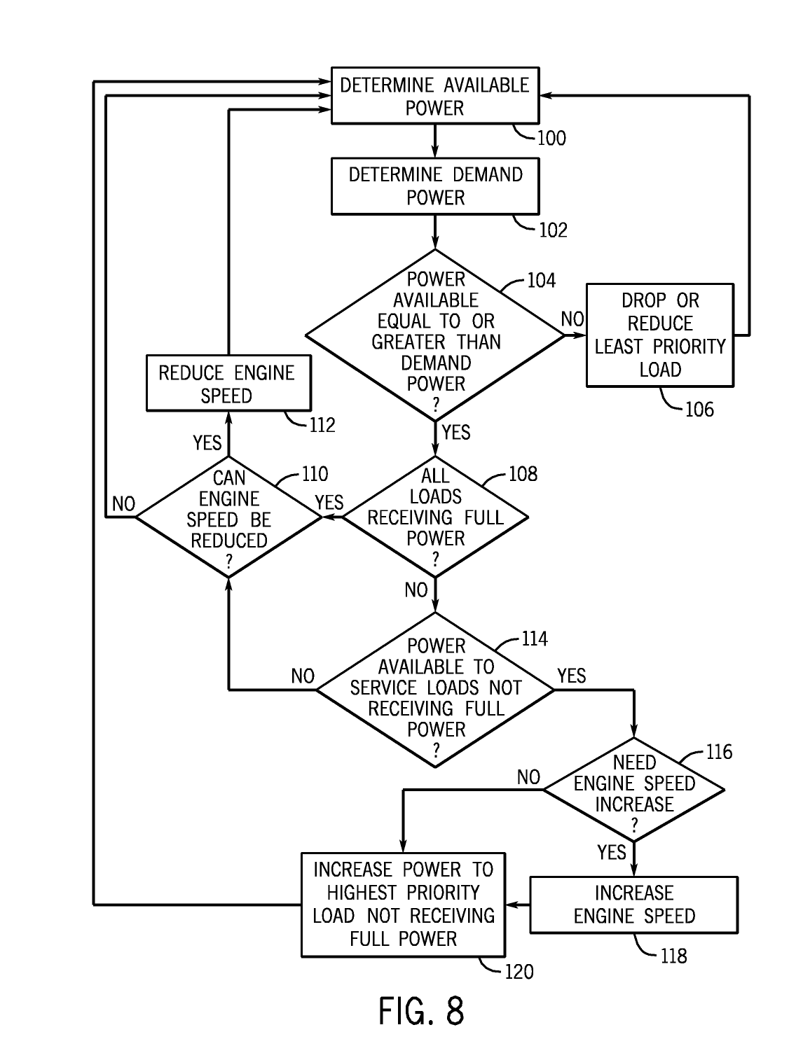

FIG. 8 depicts a flowchart of a process used to regulate and monitor the resources provided by AWP 10 in accordance with certain embodiments of the present technique. The process includes identifying the characteristics of the engine 50 and the power demanded by the devices of the AWP 10, followed by a sequence to reduce, or eliminate lower priority loads if the engine is not capable of supplying the full power demanded. Further, the process reduces the engine operating speed if the engine 50 is capable of supplying power in excess relative to the power demanded by the devices. The process may utilize a controller having a microprocessor and memory with instructions stored on the memory. Alternatively, the process may utilize a programmable logic controller (PLC) with instructions stored on the PLC. Other controllers also may be used to carry out instructions associated with the process as discussed below.

The process may first determine the available power, as illustrated at block 100. Determining the available power 100 may include determining the amount of power output by the engine 50, the generator 58, the rotary compressor 12, or a combination thereof, for consumption by various devices. For example, an engine with a 64 Hp rating may be capable of outputting approximately 47.7 kW of power, assuming that the entire 64 Hp is transmitted as an output. The available power may also be determined by other methods, including measuring the actual power output by the engine 50. For example, the available power may be calibrated at the time of manufacture and stored in memory. In another embodiment, the available power may be monitored by and stored in the controller. For example, the controller may monitor the operating characteristics of the engine 50 and detect a reduction in engine operating speed, or other system parameters, under certain load conditions. Based on the response of the engine 50 to the loads, the system may store this value in the controller as the available power of the engine 50. This process may prove useful to account for variation in engine performance over the life of the engine 50.

The process may also determine the demand for power, as illustrated at block 102. Determining the demand for power may include determining the maximum amount of power consumed by the devices. For example, if the system has three of five devices consuming power (i.e., turned on), the power demanded may include the sum of the power desired or required to operate the three devices at maximum power. Similarly, if all five devices are consuming power, power demanded may include the sum of the power to operate the five devices at maximum power. For simplicity, the process may simply determine the sum of the power to operate the five devices, even if all five of the devices are not consuming power. Examples of loads may include the load of the rotary compressor 12, the generator 58, and the like.

In another embodiment, determining the demand power 102 may include the system 10 considering the actual demand for power. For example, each of the devices may be monitored to determine the power being consumed by each respective device during operation. Monitoring may include receiving and processing signals indicative of the device speed or other data indicative of the power consumed, such as the power output by each of the devices. A comparison of the sum of the power consumed by each of the devices may be made to determine the demand power 102. Embodiments may also include providing an additional factor to maintain an available power that is greater than the demand power. For example, an additional amount of power may be added to the sum of the power consumed by the devices to ensure that the power available is capable of supporting fluctuations in the power demanded by the devices.

Based on the available power and the demand power, the controller may then determine if the power available is equal to or greater than the demand power 104. In an embodiment, this may include comparing the available power from block 100 to the demand power from block 102. For example, after making the determinations in block 100 and block 102, the controller may subtract the demand power from the available power to determine if a power surplus or power shortage exists. Similarly, an embodiment may combine the steps of block 100, 102 and 104 into a single step that includes monitoring various parameters to detect that the power available is equal to or greater than the demand power. Other embodiments may include monitoring oil temperature, coolant temperature, device power output, and the like.

If the controller determines that the power available is not equal to or greater than the demand power, then the controller may drop or reduce the lowest priority load, as depicted by block 106. In an embodiment, this may include prioritizing each load and reducing the power distributed to each load accordingly. For example, an embodiment may include categorizing the overload based on the amount of power demanded in excess of the power available. Such an embodiment may include three categories, including low overload, medium overload, and a high overload. If the overload is low, the system may reduce power to the lowest priority device or devices. If the overload is medium, the system may remove power from the lowest and/or medium priority device or devices. If the overload is high, the system may drop power to all of the devices, except for those considered the highest priority loads.

Returning now to block 104, if the controller determines that the power available is equal to or greater than the demand power, the controller may continue to regulate the performance of the engine 50 and the devices. In an embodiment, the process may confirm whether all loads are receiving full power, as depicted at block 108. Such a determination may be made by the controller to determine whether the controller may continue with the same power regulatory scheme in place or whether previously eliminated/reduced power to devices may be allowed to operate at full power consumption.

Where available power exceeds demanded power and all loads (e.g., devices) are receiving full power, it may be indicative of a power surplus. Accordingly, the controller may consider whether the operating speed of the engine 50 may be reduced. For example, if the controller determines that the available power exceeds the demand power by a sufficient amount the controller may command to reduce engine speed, as depicted at block 112. If the available power does not exceed the demand power by a sufficient amount the priority control may not command a reduction in engine speed 50 as depicted by the return to the beginning of the method of FIG. 8.

Returning now to block 108, if all loads are not receiving full power, the process on the controller may consider bringing increasing power to loads that were previously reduced to a limited power level. As depicted at block 114, the controller may first consider whether power is available to service loads not receiving full power. For example, the controller may compare the power surplus to the additional power suitable to remove a power limitation from a device. If it is determined that the controller may not service an additional load, then the process may return to block 110 to consider whether the engine speed may be reduced. However, if the controller determines that the power surplus is sufficient to service a currently limited load, the controller may increase the power supplied to the load. For example, as depicted at block 116, the controller may consider the current engine operating speed, and determine whether the system needs an engine speed increase, as depicted at block 116, to support the additional load. If no engine speed increase is needed, the controller may increase power to the highest priority load not receiving full power, as depicted at block 120. However, if the controller determines that an engine speed increase is needed, the controller may command an increase in engine speed, as depicted at block 118, before increasing power to the highest priority load not receiving full power, as depicted at block 120.

Moreover, the engine speed may be reduced or turned off during non-use to reduce noise and fuel consumption when not servicing a load. For example, if there is no draw on the generator 58 after a time, the engine speed may decrease from an idle speed to a low idle speed, or operation of the engine 50 may be temporally interrupted, reducing the engine speed to off. Upon detection of a draw on the engine at a time, the engine speed may ramp up to an operating speed using any of the control techniques discussed above.

While only certain features of the invention have been illustrated and described herein, many modifications and changes will occur to those skilled in the art. It is, therefore, to be understood that the appended claims are intended to cover all such modifications and changes as fall within the true spirit of the invention.

1. An aerial work platform, comprising:
a platform comprising a hydraulic lift; and
a base unit, comprising:
a combustion engine;
a hydraulic pump driven by the combustion engine, wherein the hydraulic pump is configured to drive the hydraulic lift; and
a rotary compressor driven by the combustion engine.

2. The aerial work platform of claim 1, wherein the rotary compressor comprises a rotary screw compressor.

3. The aerial work platform of claim 1, wherein the rotary compressor is tankless.

4. The aerial work platform of claim 1, wherein the platform comprises a boom having a plurality of boom sections movable by the hydraulic lift.

5. The aerial work platform of claim 1, wherein the base unit comprises a clutch assembly configured to couple the combustion engine selectively with the rotary compressor.

6. The aerial work platform of claim 1, wherein the base unit comprises an electrical generator driven by the combustion engine.

7. The aerial work platform of claim 1, wherein the rotary compressor comprises integrated oil filter and oil cooling systems.

8. The aerial work platform of claim 1, wherein the rotary compressor is configured to use hydraulic fluid from the hydraulic pump as a lubricant.

9. The aerial work platform of claim 6, comprising a belt and pulley assembly coupling the combustion engine to both the rotary compressor and the electrical generator.

10. The aerial work platform of claim 6, wherein the base unit comprises a load controller configured to adjust various loads on the combustion engine, the generator, or the compressor, or a combination thereof, in response to sensor feedback.

11. A system, comprising:
an aerial work platform, comprising:
a platform;
a lift coupled to the platform;
a base coupled to the lift;
a power pack coupled to the base, wherein the power pack is configured to drive the lift, and the power pack comprises an air supply consisting essentially of a rotary screw air compressor.

12. The system of claim 11, wherein the lift comprises a hydraulically-powered lift or a pneumatically powered lift.

13. The system of claim 11, wherein the power pack comprises a compression ignition engine or a spark ignition engine.

14. The system of claim 11, wherein the power pack comprises an electrical generator.

15. The system of claim 11, wherein the power pack comprises a hydraulic pump.

16. The system of claim 11, wherein the platform comprises steering and drive controls configured to control movement of the base.

17. The system of claim 11, wherein the screw-driven air compressor is tankless.

18. The system of claim 11, wherein the base comprises an enclosure, the power pack is disposed within the enclosure, and the power pack comprises a combustion engine, a hydraulic pump driven by the combustion engine, and the rotary screw air compressor driven by the combustion engine.

19. The system of claim 14, wherein the power pack comprises an engine, an electrical generator, and the rotary screw compressor, and the engine drives both the electrical generator and the rotary screw compressor in a series arrangement.

20. The system of claim 18, wherein the rotary screw air compressor is configured to use hydraulic fluid from the hydraulic pump as a lubricant.

21. The system of claim 18, wherein the base comprises a load controller configured to adjust various loads on the combustion engine or the compressor, or a combination thereof, in response to sensor feedback.

22. A method of operating an aerial work platform, comprising:
compressing air at a base of the aerial work platform via a rotary air compressor; and
outputting the air from the rotary air compressor at a generally stable pressure without fluctuations characteristic of a reciprocating air compressor.

23. The method of claim 22, wherein compressing the air comprises rotating a screw element to compress the air through a series of volume-reducing cavities.

24. The method of claim 22, wherein outputting the air comprises directly outputting the air to a desired application without passing the air through a storage tank.

25. The method of claim 22, comprising generating electricity at the base of the aerial work platform via an engine and a generator.

26. The method of claim 22, comprising generating hydraulic power at the base of the aerial work platform via an engine and a hydraulic pump.

27. The method of claim 26, comprising driving a hydraulic lift coupled to a platform of the aerial work platform via the generated hydraulic power.
